(19) United States
(12) Patent Application Publication
(10) Pub. No.: US 2012/0209575 A1
(43) Pub. Date: Aug. 16, 2012

(54) Method and System for Model Validation for Dynamic Systems Using Bayesian Principal Component Analysis

(75) Inventors: Saeed David Barbat, Novi, MI (US); Yan Fu, Canton, MI (US); Xiaomo Jiang, Dearborn, MI (US); Parakrama Valentine Weerappuli, West Bloomfield, MI (US); Ren-Jye Yang, Troy, MI (US); Guosong Li, Novi, MI (US)

(73) Assignee: FORD GLOBAL TECHNOLOGIES, LLC, Dearborn, MI (US)

(21) Appl. No.: 13/025,497

(22) Filed: Feb. 11, 2011

(51) Int. Cl. G06F 17/10

(52) U.S. Cl. 703/2

(57) ABSTRACT

A method and system for assessing the accuracy and validity of a computer model constructed to simulate a multivariate complex dynamic system. The method and system exploit a probabilistic principal component analysis method along with Bayesian statistics, thereby taking into account the uncertainty and the multivariate correlation in multiple response quantities. It enables a system analyst to objectively quantify the confidence of computer models/simulations, thus providing rational, objective decision-making support for model assessment. The validation methodology has broad applications for models of any type of dynamic system. In a disclosed example, it is used in a vehicle safety application.

### TECHNICAL FIELD

The invention relates to computer models used to simulate dynamic systems, and to a method and system for evaluating the accuracy and validity of such models.

### BACKGROUND

Model validation refers to the methods or processes used to assess the validity of computer models used to simulate and predict the results of testing perform on real-world systems. By comparing the model prediction output data with the test result data, the predictive capabilities of the model can be evaluated, and improvements can be made to the model if necessary. Model validation becomes particularly complex when the multivariate model output data and/or the test data contain statistical uncertainty.

Traditionally, subjective engineering judgments based on graphical comparisons and single response quantity-based methods are used to assess model validity. These methods ignore many critical issues, such as data correlation between multiple variables, uncertainty in both model prediction and test data, and confidence of the model. As a result, these approaches may lead to erroneous or conflicting decisions about the model quality when multiple response quantities and uncertainty are present.

In the development of passenger automotive vehicles, the amount and complexity of prototype testing to evaluate the quality and performance of vehicles in order to meet current and future safety requirements are on the rise. Computer modeling and simulations are playing an increasingly important role in reducing the number of actual vehicle prototype tests and thereby shortening product development time. It may ultimately be possible to replace the physical prototype testing and to make virtual or electronic certification a reality. To achieve this, the quality, reliability and predictive capabilities of the computer models for various vehicle dynamic systems with multiple response quantities must be assessed quantitatively and systematically. In addition, increasing attention is currently being paid to quantitative validation comparisons considering uncertainties in both experimental and model outputs.

### SUMMARY

In the disclosed methodology, advanced validation technology and assessment processes are presented for analysis of multivariate complex dynamic systems by exploiting a probabilistic principal component analysis method along with Bayesian statistics approach. This new approach takes into account the uncertainty and the multivariate correlation in multiple response quantities. It enables the system analyst to objectively quantify the confidence of computer simulations, thus providing rational, objective decision-making support for model assessment. The proposed validation methodology has broad applications for models of any type of dynamic system. In the exemplary embodiment discussed herein it is used in a vehicle safety application.

### BRIEF DESCRIPTION OF THE DRAWINGS

FIG. 1 is flow chart showing a methodology for validating a computer model of a dynamic system in relation to the actual system which the model simulates;

FIGS. 2A-2C are graphs or test data and model prediction data for nine different response quantities in a test sequence of a child restraint seat;

FIG. 3 is a table summarizing the coefficient matrix of the first three principal components of one test data set;

FIG. 4 is a graph showing actual test data and model prediction data in terms of the first principal component with a 95% error bound for each data set; and

FIG. 5 is a schematic diagram of a computer system for performing the methodology disclosed herein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

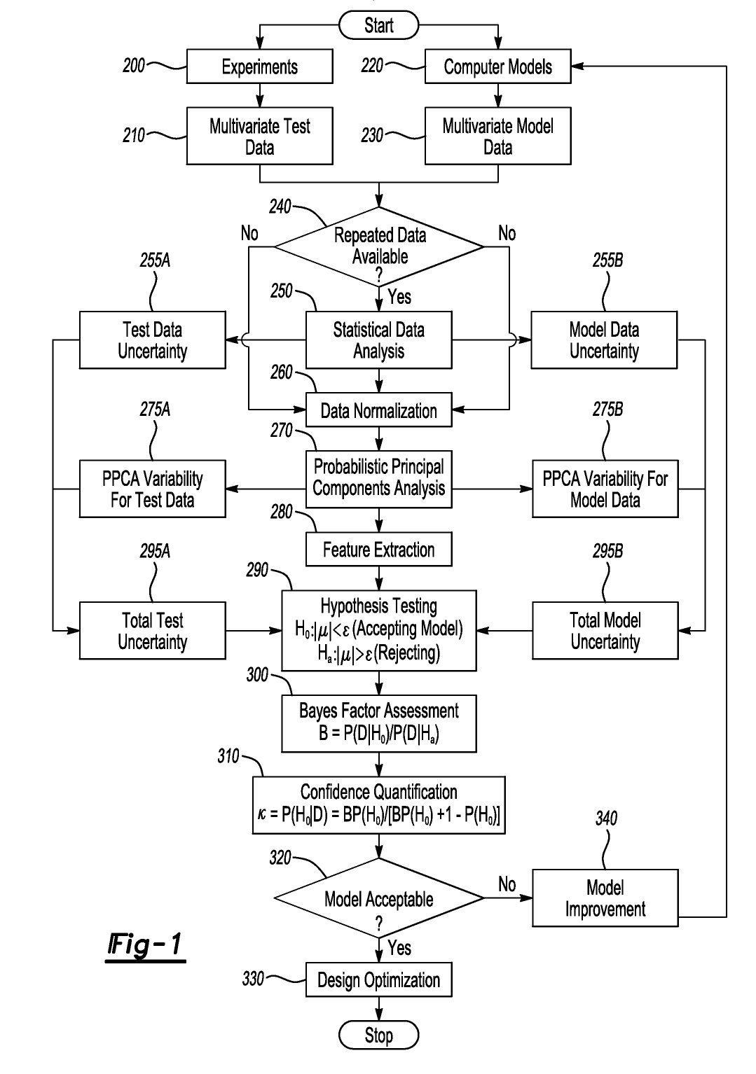

As generally depicted in FIG. 1, a probabilistic methodology for model validation of complicated dynamic systems with multiple response quantities uses Probabilistic Principal Component Analysis (PPCA) and multivariate Bayesian hypothesis testing.

In the disclosed methodology, advanced validation technology and assessment processes are used for analysis of multivariate complex dynamic systems by exploiting a probabilistic principal component analysis method along with Bayesian statistics approach. This approach takes into account the uncertainty and the multivariate correlation in multiple response quantities. It enables the system analyst to objectively quantify the confidence of computer simulations, thus providing rational, objective decision-making support for model assessment. The disclosed validation methodology has broad applications for models of any type of dynamic system.

At block 200, experimental tests are performed on a subject mechanical system which is being analyzed. Such tests may typically include multiple test runs with various test configurations, initial conditions, and test inputs. The experimental tests thus yield, at block 210, a set of multivariate test data.

At block 220, a computer model of the subject mechanical system is created using known computer modeling techniques. The computer model is used to simulate the experimental test procedure, using the same test configurations, initial conditions, and test inputs, and thus yields, at block 230, a set of multivariate model data.

If repeated data for any of the variables is obtained from the experimental tests and/or the corresponding model simulations (block 240, “YES”), statistical data analysis is performed on the data for those variables (block 250) to quantify the uncertainty for each variable, if applicable, of the test data and the model data (blocks 255A and 255B). Note that, in the context of model validation as described herein, repeated data may be available because the experimental test(s) and/or model prediction(s) may be repeated, and/or each response quantity of interest may be measured or simulated more than one time.

For example, the measurement or prediction error corresponding to each variable can be quantified as an additional error vector ε*ᵢ. The additional error may be assumed to be independently distributed Gaussian variables with zero mean and variance Λ, i.e., εᵢ˜N(0, Λ), in which Λ is a diagonal data matrix Y, in which each diagonal element represents the data uncertainty of the corresponding variable. As such, the data matrix Y in the subsequent analysis becomes the time-dependent mean value of the data for each variable.

The next step is to normalize each set of response data to a dimensionless vector, as is well known in the field of statistical analysis (block 260). This step enables different response quantities to be compared simultaneously to avoid the duplicate contribution of the same response quantity to model validation result.

At block 270, probabilistic principal component analysis (PPCA) is performed on both the test data and the model prediction data. This step addresses multivariate data correlation, quantifies uncertainty, and reduces data dimensionality to improve model validation efficiency and accuracy. PPCA, as is well known, yields a set of eigenvalues and eigenvectors representing the amount of variation accounted for by the principal component and the weights for the original variables (blocks 275A and 275B). Additional description of PPCA may be found in the appropriate section below.

At block 280, features are extracted from the multivariate PPCA-processed data to represent the properties of underlying dynamic systems. This is referred to as dimensionality reduction and involves a determination of the proper number of principal components to retain. In this case, the intrinsic dimensionality of the data is used as the proper number. The intrinsic dimensionality is the minimum number of latent variables necessary to account for an amount of information in the original data determined to be sufficient for the required level of model accuracy. Various methods may be used to estimate the intrinsic dimension, such as standard PCA or the maximum likelihood method. The eigenvalues corresponding to the principal components in PCA represent the amount of variance explained by their corresponding eigenvectors. The first d eigenvalues are typically high, implying that most information (which may be expressed as a percentage) is accounted for in the corresponding principal components.

Thus, the estimation of the intrinsic dimensionality d may be obtained by calculating the cumulative percentage of information contained in the first d eigenvalues (i.e., the total variability by the first d principal components) that is higher than a desired threshold value ε_{d}. The result is that the retained d principal components account for the desired percentage of information of the original data.

Next, one or more statistical hypotheses are built on the feature difference between the test data set and the model data set, and these hypotheses are tested to assess whether the model is acceptable or not (block 290). An example of a method of binary hypothesis testing is shown in block 290, and explained further below in the section titled “Interval Bayesian Hypothesis Testing.” This step considers the total uncertainty in both test data (block 295A) and the model data (block 295B). The total uncertainty in each data set includes contributions from both the data uncertainty (blocks 255A, 255B) and variability from the PCA (blocks 295A, 295B).

At block 300, a Bayes factor is calculated to serve as a quantitative assessment metric from the hypotheses and the extracted features. An example of Bayes factor assessment is shown in block 300, and explained further below in the section titled “Bayesian measure of evidence of validity.”

At block 310, the level of confidence of accepting the model is quantified by calculating a confidence factor (see Eqn. 16 below). The confidence factor may then be evaluated to determine whether the model is acceptably accurate (block 320). This may be done, for example, by comparing the confidence factor with a minimum value that is deemed appropriate for acceptance of the model. The confidence factor therefore provides quantitative, rational, and objective decision support for model validity assessment.

The quantitative information (e.g., confidence level) obtained from the above process may be provided to decision makers for use in assessing the model validity and predictive capacity. If the model is validated with an acceptable confidence level (block 320, “YES”), design optimization can be performed on the system under analysis (block 330) to improve performance and/or quality, and/or to reduce cost, weight, environmental impact, etc. If the model is not acceptably valid (block 320, “NO”), the model may modified to improve its accuracy or replaced by a different model (block 340). The validation process may then be repeated if necessary.

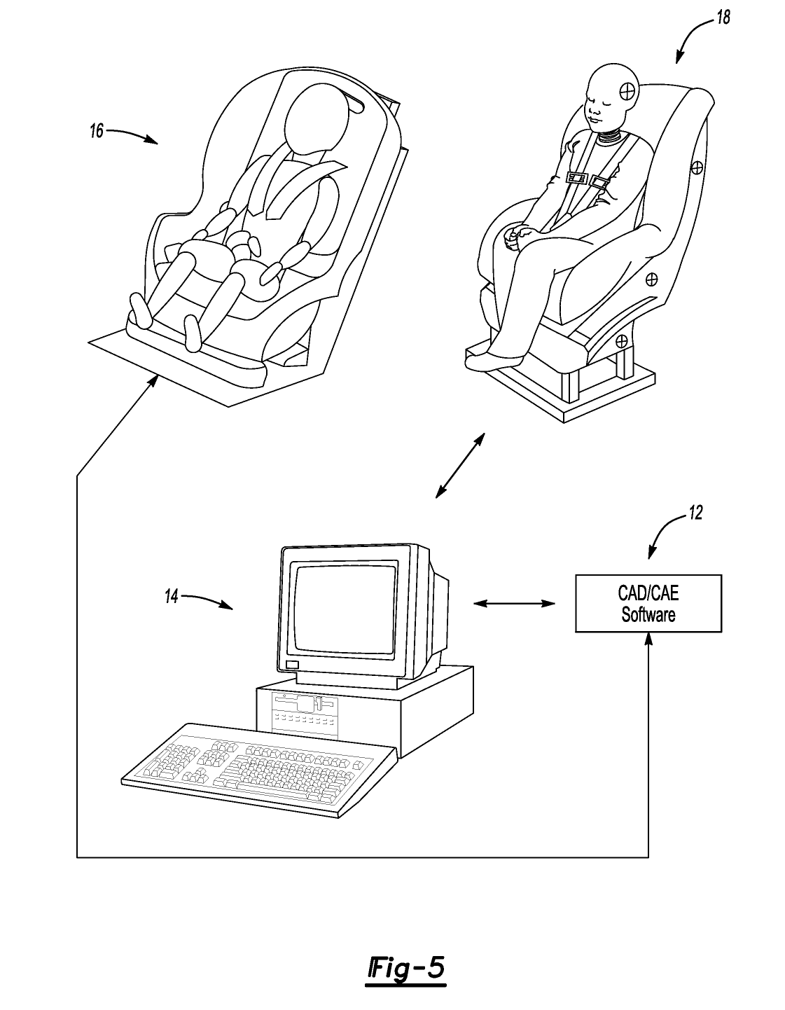

An example of the present validation method is described in relation to a testing program carried out on a rear seat child restraint system (of the general type commonly used in passenger vehicles) utilizing an instrumented dummy model (see FIG. 5, reference number 18). Sixteen tests are conducted with different configurations of the restraint system, including two seat cushion positions, two top tether routing configurations, and four input crash pulses. In each test, nine response quantities are measured at a variety of locations of the dummy model.

A computer model is constructed (using well-known modeling techniques) and used to simulate the actual tests (FIG. 5, reference number 16). Sixteen sets of prediction outputs (each containing the corresponding nine response quantities measured during the experimental testing) are generated from the model.

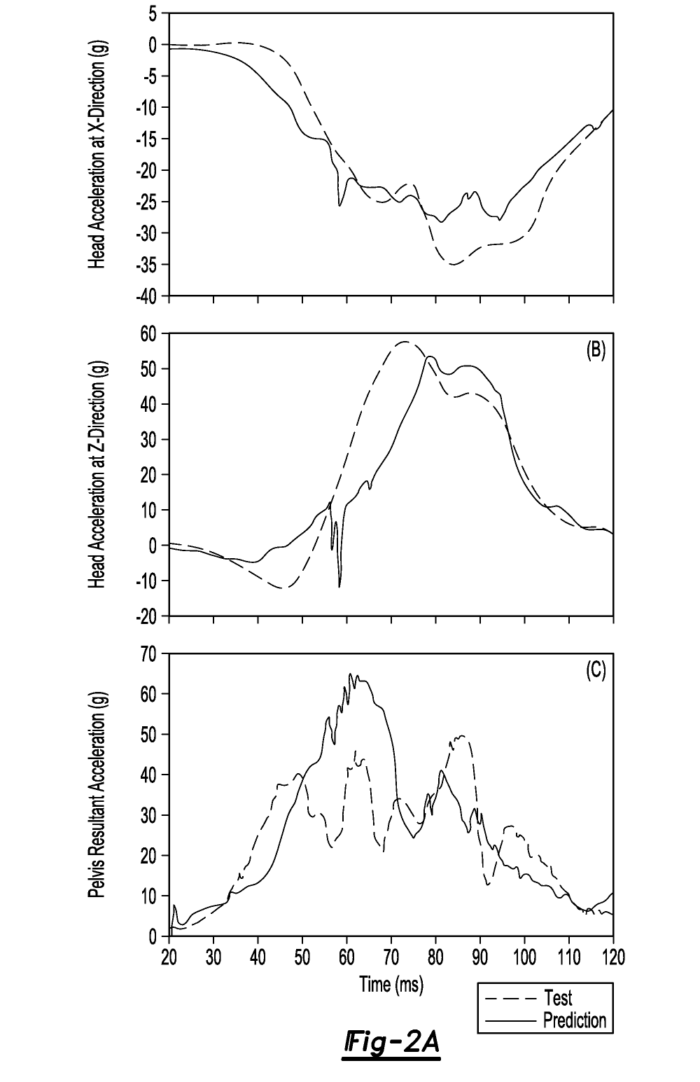

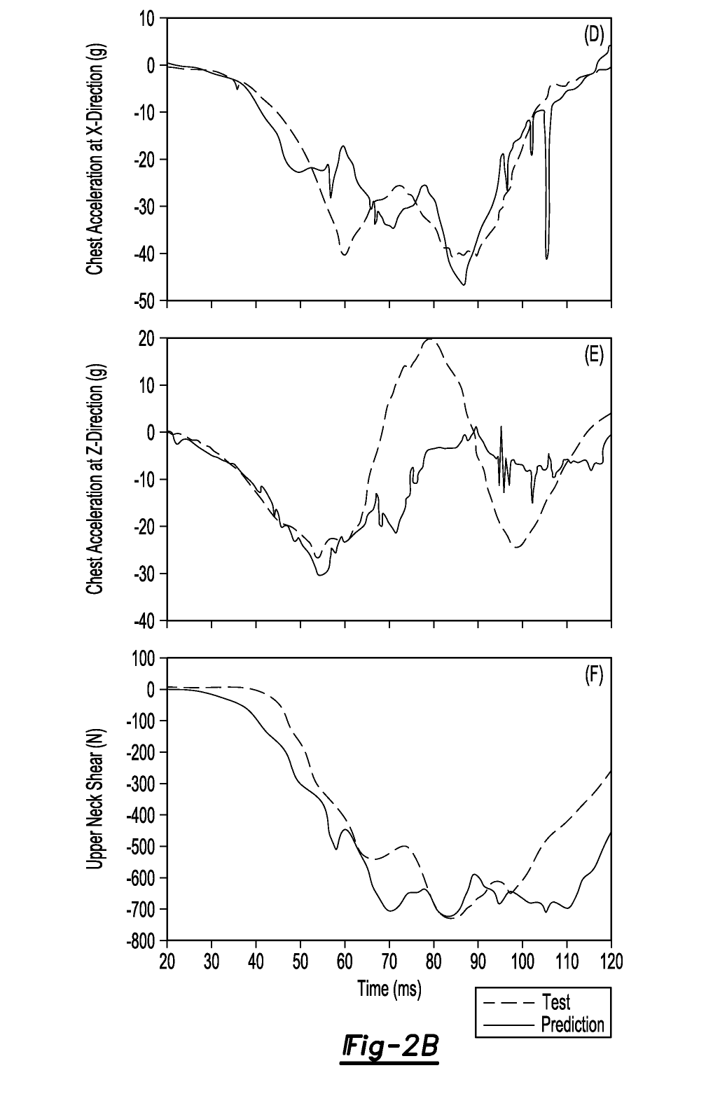

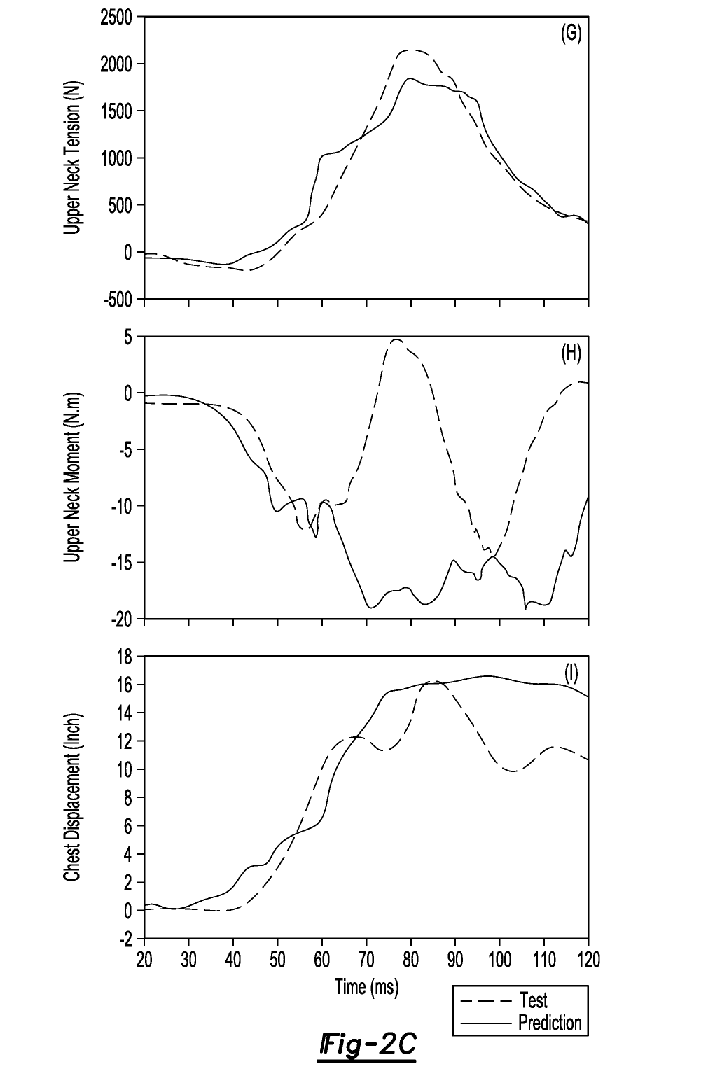

FIG. 2 shows time history plots for one data set with nine responses, each containing 200 data points. Note that it is difficult to assess and/or quantify the model validity based on qualitative graphical comparisons with any one data set. The model may be judged to be sufficiently accurate/valid based on a relatively close visual match with test data for one or more of the experimental results. For example, the upper neck tension graph of FIG. 2g shows a good fit between the test results and the model prediction. Alternatively, the model may be judged to be not sufficiently accurate/valid based on examination of other responses that show a poor match with the corresponding test data (e.g., the upper neck moment shown in FIG. 2h). This demonstrates that model validation based on individual response quantities may result in conflicting conclusions.

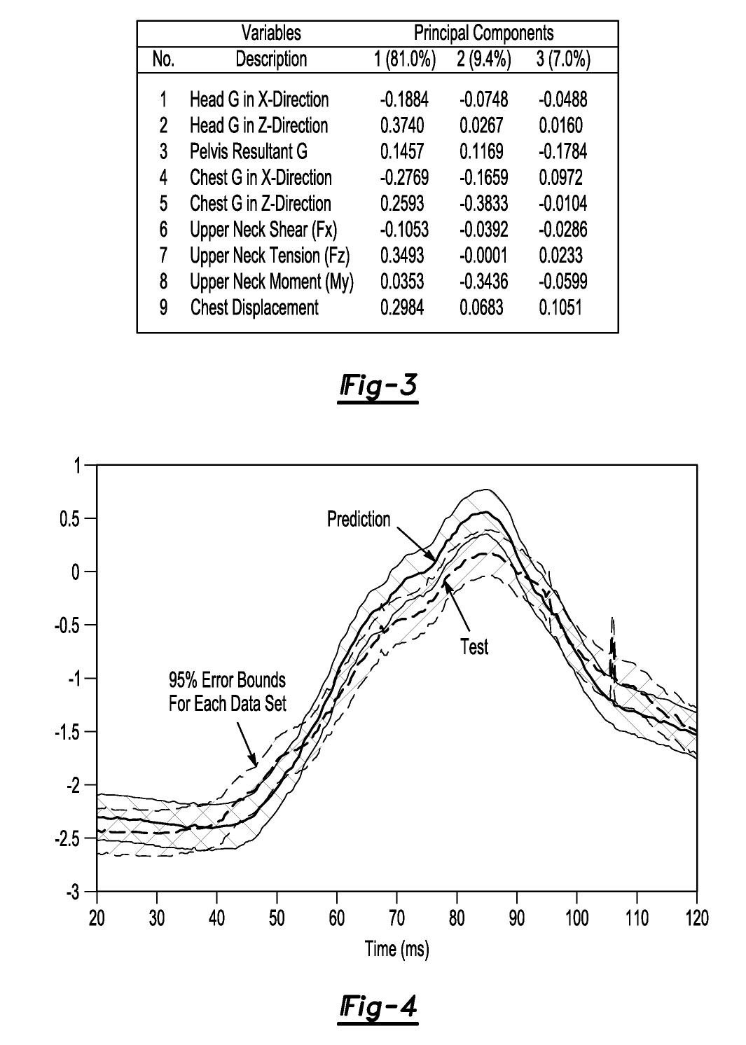

Following the procedure shown in FIG. 1, the sixteen data sets are normalized and probabilistic PPCA is performed on each normalized data set. In this example, a value of 95% is used as the desired level of accuracy. Accordingly, the reduced data matrix is analyzed to find the first d features that will account for at least 95% of the information in the original data. The value of d=3 is obtained for the test data. The table of FIG. 3summarizes the coefficient matrix of PPCA for the first three principal components of one test data set. Each cell of the table shows the weight of the response contributing to the corresponding principal component. PPCA effectively identifies the critical variables which make significant contribution to the principal component.

FIG. 4 shows the comparison of the test data and the model data output in terms of the first principal component with a 95% error bound for each data set. Multivariate Bayesian hypothesis testing (as explained in further detail in the sections below) is then conducted on the first three principal components (3×200) for each test configuration, resulting in 16 Bayes factor values B with the mean value of 2.66 (see Eq. 13 below) and the probability of accepting the model with the mean value of 72.7%, obtained from the Bayesian hypothesis testing, i.e., the model is accepted with the confidence of 72.7% (see Eq. 17 below).

The disclosed method may be used to shorten vehicle development time and reduce testing. Possible benefits may include:
Ability to quickly, quantitatively assess a multivariate computer model using only one test.
Applicability to various complicated dynamic problems with any number of response variables.
Consideration of uncertainty in both test data and model prediction.
Consideration of correlation between multiple response quantities.
Confidence quantification of model quality for complicated dynamic systems.
Easy incorporation of the existing features extracted from response quantities.
Reducing subjectivity in decision making on model validity and model improvement.
Easy incorporation of expert opinion and prior information about the model validity.

FIG. 5 illustrates a system for evaluating validity of a computer model of a dynamic system. The system includes software 12 and hardware 14 for constructing a computer model 16 of a dynamic system and running simulations using such a model. The software 12 may be a computer aided design and engineering (CAD/CAE) system of the general type well known in the art. The hardware 14 is preferably a micro-processor-based computer and includes input/output devices and/or ports.

The software 12 and hardware 14 are also capable of receiving data from test apparatus 18, including the output of sensors which gather the results of test run using the equipment. The test data gathered from the test apparatus 18 may be transferred directly to the hardware 14 if appropriate communications links are available, and/or they may be recorded on removable data storage media (CD-ROMs, flash drives, etc.) at the site of the testing, physically transported to the site of the hardware 14, and loaded into the hardware for use in the model validation method as described herein.

Using the system of FIG. 5, the model validity evaluation method(s) described herein may be performed and the resulting confidence factor output so that a decision maker (such as an engineer or system analyst) may decide whether the model under evaluation is acceptably valid.

### Probabilistic PCA

Principal component analysis (PCA) is a well-known statistical method for dimensionality reduction and has been widely applied in data compression, image processing, exploratory data analysis, pattern recognition, and time series prediction. PCA involves a matrix analysis technique called eigenvalue decomposition. The decomposition produces eigenvalues and eigenvectors representing the amount of variation accounted for by the principal component and the weights for the original variables, respectively. The main objective of PCA is to transform a set of correlated high dimensional variables to a set of uncorrelated lower dimensional variables, referred to as principal components. An important property of PCA is that the principal component projection minimizes the squared reconstruction error in dimensionality reduction. PCA, however, is not based on a probabilistic model and so it cannot be effectively used to handle data containing uncertainty.

A method known as probabilistic principal component analysis (PPCA) has been proposed to address the issue of data that contains uncertainty (see Tipping and Bishop, 1999). PPCA is derived from a Gaussian latent variable model which is closely related to statistical factor analysis. Factor analysis is a mathematical technique widely used to reduce the number of variables (dimensionality reduction), while identifying the underlying factors that explain the correlations among multiple variables. For convenience of formulation, let Y=[y₁, . . . , y_{N}]^{T} represent the N×D data matrix (either model prediction or experimental measurement in the context of model validation) with yᵢε [symbol] , which represents D observable variables each containing N data points. Let Φ=[θ₁, . . . , θ_{N}]^{T} be the N×d data matrix with θᵢε [symbol] (d≦D) representing d latent variables (factors) that cannot be observed, each containing the corresponding N positions in the latent space. The latent variable model relates the correlated data matrix Y to the corresponding uncorrelated latent variable matrix Φ, expressed as

yᵢ=Wθᵢ+μ+εᵢi=1, 2, . . . , N, (1)

where the D×d weight matrix W describes the relationship between the two sets of variables yᵢ and θᵢ, the parameter vector μ consists of D mean values obtained from the data matrix Y, i.e. μ=(1/N)Σᵢ₋₁^{N}yᵢ, and the D-dimensional vector εᵢ represents the error or noise in each variable yᵢ, usually assumed to consist of independently distributed Gaussian variables with zero mean and unknown variance ψ.

PPCA may be derived from the statistical factor analysis with an isotropic noise covariance σ²I assumed for the variance ψ (see Tipping and Bishop, 1999). It is evident that, with the Gaussian distribution assumption for the latent variables, the maximum likelihood estimator for W spans the principal subspace of the data even when the σ² is non-zero. The use of the isotropic noise model σ²I makes PPCA technically distinct from the classical factor analysis. The former is covariant under rotation of the original data axes, while the latter is covariant under component-wise rescaling. In addition, the principal axes in PPCA are in the incremental order, which cannot be realized by factor analysis.

In the example of model validation described herein, the test or model prediction may be repeated, or each response quantity of interest may be measured or simulated more than one time. In such situation, the measurement or prediction error corresponding to each variable can be quantified by statistical data analysis, yielding an additional error vector ε*ᵢ. The additional error is also assumed to be independently distributed Gaussian variables with zero mean and variance Λ, i.e., εᵢ˜N(0, Λ), in which Λ is a diagonal matrix, each diagonal element representing the data uncertainty of the corresponding variable. As such, the data matrix Y in the subsequent analysis becomes the time-dependent mean value of the data for each variable.

The latent variables θᵢ in Eq. (1) are conventionally defined to be independently distributed Gaussian variables with zero mean and unit variance, i.e. θᵢ˜N(0, I). From Eq. (1), the observable variable yᵢ can be written in the Gaussian distribution form as

yᵢ|(θᵢ,W,ψ)˜N(Wθᵢ+μ,ψ), (2)

where ψ=Λ+σ²I combines the measurement or prediction error Λ unique to the response quantity and the variability σ² unique to θᵢ (the isotropic noise covariance).

It should be pointed out that the latent variables θᵢ in the PPCA are intended to explain the correlations between observed variables yᵢ, while the error variables εᵢ represents the variability unique to θᵢ. This is different from standard (non-probabilistic) PCA which treats covariance and variance identically. The marginal distribution for the observed data Y can be obtained by integrating out the latent variables (Tipping and Bishop, 1999):

Y|W,ψ˜N(μ,WW^{T}+ψ), (3)

Using Bayes' Rule, the conditional distribution of the latent variables Φ given the data Y can be calculated by:

Φ|Y˜N(M⁻¹W^{T}(Y−μ),Σ⁻¹), (4)

where M=σ²I+W^{T}W and Σ=I+W^{T}ψ⁻¹W are of size d×d [note that WW^{T}+ψ in Eq. (3) is D×D]. Equation (4) represents the dimensionality reduction process in the probabilistic perspective.

In Eq. (2), the measurement error covariance Λ is obtained by statistical error analysis. We need to estimate only the parameters W and σ². Let C=WW^{T}+ψ denote the data covariance model in Eq. (3). The objective function is the log-likelihood of data Y, expressed by

$$log L = - \frac{N}{2} [ D ln ( 2 π ) + ln \vert C \vert + tr ( {C}^{- 1} S ) ] , \qquad ( 5 )$$

where S=cov(Y) is the covariance matrix of data Y, and the symbol tr(C⁻¹S) denotes the trace of the square matrix (the sum of the elements on the main diagonal of the matrix C⁻¹S).

The maximum likelihood estimates for σ² and W are obtained as:

$$\begin{matrix}{σ}_{ML}^{2} = \frac{1}{D - d} {\sum }_{i = d + 1}^{D} {λ}_{i} , & ( 6 ) \\ {W}_{ML} = {{U}_{d} ( {Γ}_{d} - {σ}_{ML}^{2} I )}^{1 / 2} , & ( 7 )\end{matrix}$$

where U_{d} is a D×d matrix consisting of d principal eigenvectors of S, and Γ_{d} is a d×d diagonal matrix with the eigenvalues λ₁, . . . , λ_{d}, corresponding to the d principal eigenvectors in U_{d}. (Refer to Tipping and Bishop, Probabilistic Principal Component Analysis, Journal of the Royal Statistical Society: Series B (Statistical Methodology) 1999; 61(3): 611-622.)

The maximum likelihood estimate of σ² in Equation (6) is calculated by averaging over the omitted dimensions, which interpreting the variance without being accounted for in the projection, and is not considered in the standard PCA. However, similar to the standard PCA, Equation (7) shows that the latent variable model in Eq. (1) maps the latent space into the principal subspace of the data.

From Eq. (4), we can construct the lower d-dimensional data matrix by calculating the mean value of Φ, μ_{Φ}, expressed by

μ_{Φ}=M_{ML}⁻¹W_{ML}^{T}(Y−μ (8)

where M_{ML}=\tilde{σ}_{ML}²I+W_{ML}^{T}W, and the variance of the d-dimensional data matrix is

Σ_{ML}⁻¹=I+\tilde{W}_{ML}^{T}ψ_{ML}⁻¹\tilde{W}_{ML}, (9)

where ψ_{ML}=Λ+σ_{ML}²I.

Note that the d-dimensional data obtained by Eq. (8) has a zero mean because the original data has been adjusted by minus its mean (i.e., Y−μ). Thus the latent variables θᵢ in Eq. (1) satisfy the standard Gaussian distribution assumption N(0, I). In the context of model validation, it is appropriate to use the unadjusted data in the lower dimensional latent space, Φ*=[θ*₁, . . . , θ*_{N}]^{T}, expressed as:

Φ*=M_{ML}⁻¹W_{ML}^{T}Y, (10)

which has the mean of M_{ML}⁻¹W_{ML}^{T}μ. The data matrix Φ* and variance Σ_{ML}⁻¹ will be applied in the model assessment using the Bayesian hypothesis testing method, as discussed in the following sections.

The variance matrix Σ_{ML} in Eq. (9) incorporates both the data variability Λ obtained by statistical analysis and the variability σ_{ML}² which is omitted in the standard PCA analysis. Whereas the data matrix Φ* obtained by Eq. (10) incorporates both the original data Y via the coefficient matrix W and the variability σ_{ML} via the matrix M. Therefore, the present probabilistic PCA method is different from the standard PCA which does not account for both the data uncertainty and information variability.

The intrinsic dimensionality of the data may be used to determine the proper number of principal components to retain. The intrinsic dimensionality is the minimum number of latent variables necessary to account for that amount of information in the original data determined to be sufficient for the required level of accuracy. Various methods may be used to estimate the intrinsic dimension, such as standard PCA or the maximum likelihood method. The eigenvalues corresponding to the principal components in PCA represent the amount of variance explained by their corresponding eigenvectors. The first d eigenvalues are typically high, implying that most information is accounted for in the corresponding principal components.

Thus, the estimation of the intrinsic dimensionality d may be obtained by calculating the cumulative percentage of the d eigenvalues (i.e., the total variability by the first d principal components) that is higher than a desired threshold value ε_{d}, such as the 95% value used in the above example. This implies that the retained d principal components account for 95% information of the original data.

### Bayes Factor and Bayesian Evaluation Metric

Let Φ*ₑₓₚ=[θ*_{1,exp}, . . . , θ*_{N,exp}]^{T} and Φ*_{pred}=[θ*_{1,pred}, . . . , θ*_{N,pred}]^{T} represent the d×N reduced time series experimental data and model prediction, respectively, each set of d-dimensional variables containing N values. Within the context of binary hypothesis testing for model validation, we need to test two hypotheses H₀ and H₁, i.e., the null hypothesis (H₀: Φ*ₑₓₚ=Φ*_{pred}) to accept the model and an alternative hypothesis (H₁: Φ*ₑₓₚ≠Φ*_{pred}) to reject the model. Thus, the likelihood ratio, referred to as the Bayes factor, is calculated using Bayes' theorem as:

$${B}_{01} = \frac{f ( Data \vert {H}_{0} )}{f ( Data \vert {H}_{1} )} , \qquad ( 11 )$$

Since B₀₁ is non-negative, the value of B₀₁ may be converted into the logarithm scale for convenience of comparison over a large range of values, i.e., b₀₁=ln(B₀₁), where ln(.) is a natural logarithm operator with a basis of e. It has been proposed to interpret b₀₁ between 0 and 1 as weak evidence in favor of Hₒ, between 3 and 5 as strong evidence, and b₀₁>5 as very strong evidence. Negative b₀₁ of the same magnitude is said to favor H₁ by the same amount. (Kass and Raftery, 1995)

Various features (e.g. peak values, relative errors, magnitude and phase) may be extracted from the reduced time series data Φ*ₑₓₚ and Φ*_{pred}, and those features then used for model assessment. Note that the reduced time series data obtained from PPCA analysis are uncorrelated. Thus, an effective method is to directly assess the difference between measured and predicted time series, which reduces the possible error resulting from feature extraction.

Let dᵢ=θ*_{i,exp}−θ*_{i,pred} (i=1, . . . , N) represent the difference between the i-th experimental data and the i-th model prediction, and D={d₁, d₂, . . . , d_{N}} represent the d×N difference matrix with distribution N(δ,Σ⁻¹). The covariance Σ⁻¹ is calculated by:

Σ⁻¹=Σₑₓₚ⁻¹+Σ_{pred}⁻¹, (12)

where Σₑₓₚ⁻¹ and Σ_{pred}⁻¹ represent the covariance matrices of the reduced experimental data and model prediction, respectively, which are obtained by using Eq. (9).

### Interval Bayesian Hypothesis Testing

An interval-based Bayesian hypothesis testing method has been demonstrated to provide more consistent model validation results than a point hypothesis testing method (see Rebba and Mahadevan, Model Predictive Capability Assessment Under Uncertainty, AIAA Journal 2006; 44(10): 2376-2312). A generalized explicit expression has been derived to calculate the Bayes factor based on interval-based hypothesis testing for multivariate model validation (see Jiang and Mahadevan, Bayesian Validation Assessment of Multivariate Computational Models, Journal of Applied Statistics 2008; 35(1): 49-65). The interval-based Bayes factor method may be utilized in this example to quantitatively assess the model using multiple reduced-dimensional data in the latent variable space.

Within the context of binary hypothesis testing for multivariate model validation, the Bayesian formulation of interval-based hypotheses is represented as H₀: |D|≦εₒ versus H₁: |D|>εₒ, where ε₀ is a predefined threshold vector. Here we are testing whether the difference D is within an allowable limit ε. Assuming that the difference, D, has a probability density function under each hypothesis, i.e., D|H₀˜ƒ(D|H₀) and D|H₁˜ƒ(D|H₁). The distribution of the difference a priori is unknown, so a Gaussian distribution may be assumed as an initial guess, and then a Bayesian update may be performed.

It is assumed that: (1) the difference D follows a multivariate normal distribution N(δ, Σ) with the covariance matrix Σ calculated by Eq. (12); and (2) a prior density function of δ under both null and alternative hypotheses, denoted by ƒ(δ), is taken to be N(ρ, Λ). If no information on ƒ(δ|H₁) is available, the parameters ρ32 0 and Λ=Σ⁻¹ may be selected (as suggested in Migon and Gamerman, 1999). This selection assumes that the amount of information in the prior is equal to that in the observation, which is consistent with the Fisher information-based method.

Using Bayes' Theorem, ƒ(δ|D)∝ƒ(D|δ)ƒ(δ), the Bayes factor for the multivariate case, B_{iM}, is equivalent to the volume ratio of the posterior density of δ under two hypotheses, expressed as follows:

$${B}_{i M} = \frac{{\int }_{- ɛ}^{ɛ} f ( δ \vert D ) d δ}{{\int }_{- ∞}^{- ɛ} f ( δ \vert D ) d δ + {\int }_{ɛ}^{∞} f ( δ \vert D ) d δ} = \frac{K}{1 - K} , \qquad ( 13 )$$

where the multivariable integral of K=∫_{-ε}^{ε}ƒ(δ|D)dδ represents the volume of the posterior density of δ under the null hypothesis. The value of 1-K represents the area of the posterior density of δ under the alternative hypothesis. (Refer to Jiang and Mahadevan, Bayesian wavelet method for multivariate model assessment of dynamical systems, Journal of Sound and Vibration 2008; 312(4-5): 694-712, for the numerical integration.) Note that the quantity K in Eq. (13) is dependent on the value of ε₀. The system analyst, decision maker, or model user is able to decide what c are acceptable. In this study, for illustrative purposes, the values of ε₀ are taken to be 0.5 times of the standard deviations of the multiple variables in the numerical example.

### Bayesian Measure of Evidence of Validity

The Bayesian measure of evidence that the computational model is valid may be quantified by the posterior probability of the null hypothesis Pr(H₀|D). Using the Bayes theorem, the relative posterior probabilities of two models are obtained as:

$$\frac{Pr ( {H}_{0} \vert D )}{Pr ( {H}_{1} \vert D )} = [ \frac{Pr ( D \vert {H}_{0} )}{Pr ( D \vert {H}_{1} )} ] [ \frac{Pr ( {H}_{0} )}{Pr ( {H}_{1} )} ] \qquad ( 14 )$$

The term in the first set of square brackets on the right hand side is referred to as “Bayes factor,” as is defined in Eq. (11). The prior probabilities of two hypotheses are denoted by π₀=Pr(H₀) and π₁=Pr(H₁). Note that π₁=1−π₀ for the binary hypothesis testing problem. Thus, Eq. (14) becomes:

Pr(H₀|D)/Pr(H₁D)=B_{iM}[π₀/(1−π₀)], (15)

where Pr(H₁|D) represents the posterior probability of the alternative hypothesis (i.e., the model is rejected). In this situation, the Bayes factor is equivalent to the ratio of the posterior probabilities of two hypotheses. For a binary hypothesis testing, Pr(H₁|D)=1−Pr(H₀|D). Thus, the confidence K in the model based on the validation data, Pr(H₀|D), can be obtained from Eq. (15) as follows:

κ=Pr(H₀|D)=B_{iM}π₀/(B_{iM}π₀+1−π₀ (16)

From Eq. (16), B_{M}→0 indicates 0% confidence in accepting the model, and B_{M}→∞ indicates 100% confidence.

Note that an analyst's judgment about the model accuracy may be incorporated in the confidence quantification in Eq. (16) in terms of prior π₀. If no prior knowledge of each hypothesis (model accuracy) before testing is available, π₀=π₁=0.5 may be assumed, in which case Eq. (16) becomes:

κ=B_{iM}/(B_{iM}+1) (17)

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method of validating a model of a dynamic system comprising:
inputting a set of test data generated by conducting a plurality of tests on the dynamic system, the test data having a plurality of response quantities;
inputting a set of model data generated by using a first computer model constructed to simulate the dynamic system and the plurality of tests;
conducting statistical analysis on the test data and the model data to quantify uncertainty in the test and model data;
normalizing each set of test data and model data to create normalized data sets;
applying principal component analysis to the normalized data sets to generate a data matrix showing a weight of response for each of the response quantities and a principal component variability;
extracting principal components from the data matrix, the principal components representing significant properties of the dynamic system;
determining an intrinsic dimensionality of the data matrix to achieve a desired minimum percentage error bound of information in the original data;
testing a statistical hypothesis based on a feature differences between the test data set and the model data set to assess whether the model is acceptable or not, the hypothesis taking into account a) the quantified uncertainty in the test and model data, and b) the principal component variability;
calculating a Bayes factor from results of the hypothesis testing and the extracted features;
generating a confidence factor of accepting the model using Bayesian hypothesis testing;
outputting the confidence factor; and
comparing the output confidence factor with a minimum acceptance value and if the factor is not above the minimum acceptance value, modifying characteristics of the first computer model to create a second computer model.

2. The method according to claim 1 wherein the step of applying principal component analysis comprises applying probabilistic principal component analysis.

3. The method according to claim 1 wherein the statistical hypothesis is an interval-based Bayesian hypothesis.

4. The method according to claim 1 wherein the features extracted are at least one of a peak value, a relative error, a magnitude, and a phase.

5. The method according to claim 1 wherein the confidence of accepting the model is calculated by comparing a posterior probability of a null hypothesis with the given data.

6. A computer-implemented method of validating a model of a dynamic system comprising:
conducting a plurality of tests on a dynamic system to generate a set of test data;
construct a model simulating the dynamic system using a computer aided engineering system;
using the computer aided engineering system, simulating the plurality of tests with the model and generating a set of model data;
conducting statistical analysis on the test data and the model data to quantify uncertainty in the test and model data;
normalizing each set of test data and model data to create normalized data sets;
applying principal component analysis to the normalized data sets to generate a data matrix showing a weight of response for each of the response quantities and a principal component variability;
extracting principal components from the data matrix, the principal components representing significant properties of the dynamic system;
determining an intrinsic dimensionality of the data matrix to achieve a desired minimum percentage error bound of information in the original data;
testing a statistical hypothesis based on a feature differences between the test data set and the model data set to assess whether the model is acceptable or not, the hypothesis taking into account a) the quantified uncertainty in the test and model data, and b) the principal component variability;
calculating a Bayes factor from results of the hypothesis testing and the extracted features;
generating a confidence factor of accepting the model using Bayesian hypothesis testing;
outputting the confidence factor; and
comparing the output confidence factor with a minimum acceptance value to determine whether or not the model is acceptably valid.

7. The method according to claim 6 further comprising the step of: if the output confidence factor is not greater than the minimum acceptance value, modifying characteristics of the computer model to create a second model; and repeating the model validation process using a second set of model data generated using the second model.

8. A system for evaluating validity of a computer model of a dynamic system comprising:
a testing apparatus subjecting the dynamic system to a plurality of tests and generating a set of test data;
a computer aided engineering system simulating the plurality of tests using a model simulating the dynamic system and the testing apparatus to generate a set of model data and
a computer running software to:
conduct statistical analysis on the test data and the model data to quantify uncertainty in the test and model data;
normalize each set of test data and model data to create normalized data sets;
apply principal component analysis to the normalized data sets to generate a data matrix showing a weight of response for each of the response quantities and a principal component variability;
extract principal components from the data matrix, the principal components representing significant properties of the dynamic system;
determine an intrinsic dimensionality of the data matrix to achieve a desired minimum percentage error bound of information in the original data;
test a statistical hypothesis based on a feature differences between the test data set and the model data set to assess whether the model is acceptable or not, the hypothesis taking into account a) the quantified uncertainty in the test and model data, and b) the principal component variability;
calculate a Bayes factor from results of the hypothesis testing and the extracted features;
generate a confidence factor of accepting the model using Bayesian hypothesis testing;
output the confidence factor; and
compare the output confidence factor with a minimum acceptance value to enable a determination of whether or not the model is acceptably valid.
